(19) United States
(12) Patent Application Publication
(10) Pub. No.: US 2013/0056612 A1
(43) Pub. Date: Mar. 7, 2013

(54) Universal Multipoint Lock Lever Set For Patio Doors With Non-Standard Mounting Holes

(71) Applicant: Qianyan Cheng, Carmichael, CA (US)

(72) Inventor: Qianyan Cheng, Carmichael, CA (US)

(21) Appl. No.: 13/224,390

(22) Filed: Sep. 2, 2011

(51) Int. Cl. F16M 13/02

(52) U.S. Cl. 248/674

(57) ABSTRACT

A door lever set assembly for a patio door with non-standard center to center spacing between mounting holes includes a sub-plate adapted to be located on an outside surface of the patio door has a vertical slot near the top and bottom ends of the sub-plate, and two reinforcement blocks located between the sub-plate and the surface of the patio door where each reinforcement block has a hole aligned with a vertical slot. The reinforcement blocks slide toward or away from each other until the center to center spacing between the holes in the reinforcement blocks is the same as the center to center spacing between the mounting holes on the patio door to allow bolts to pass through the slots in the sub-plate, the holes in the reinforcement blocks and the mounting holes in the patio door. The sub-plate is adapted to be snap fit to different cover plates.

### BACKGROUND OF THE INVENTION

1. Field of the Invention

The present invention relates generally to a lock lever set and, more particularly, to a universal lock lever set for mounting to a patio door that has non-standard center to center spacing between mounting holes and rotates about at least two hinges to an open or close position.

2. Description of Related Art

Patio door lock sets are known in the prior art. More specifically, by way of example, U.S. PreGrant Publication No. 2006/0082166 to Lawrence, discloses a locking mechanism for sliding glass patio doors which has improved strength and increased resistance to forced entry for new and existing sliding glass patio doors.

U.S. Pat. No. 7,373,794 to DePass discloses a lock assembly for use with a sliding door which includes a non-handed miniature mortise lock having a retractable and extendable tongue able to move between a locked position and an unlocked position.

U.S. Pat. No. 7,261,330 to Hauber discloses a rotatable latch lever which is located beyond a vertical pull handle on a sliding door and a rotatable latch located opposite the handle so that the latch is conveniently rotatable from beyond the pull handle to avoid interference with the latch lever.

U.S. Pat. No. 6,688,656 to Becken discloses a multi-point lock and method for locking with two remote mortise locks operated by a central actuator to which they are mechanically linked. The mortise locks are mounted with opposite orientation so that they simultaneously engage separate keepers from opposite directions.

U.S. Pat. No. 5,820,170 to Clancy discloses a multi-point sliding door latch adapted to be fitted in a single opening in the lock face of a sliding door and arranged for coaction with a keeper structure on an associated jamb for coaction with a handle assembly mounted on the sliding door and including a tail member operated by a thumb turn or a key lock.

### SUMMARY OF THE INVENTION

In an exemplary embodiment of the present invention, there is disclosed a universal door lever set assembly for a patio door that has non-standard center to center spacing between mounting holes and rotates about at least two hinges to an open or close position comprising:

a first sub-plate having side walls which extend down from one side of the sub-plate wherein the edges of the side walls are adapted to be located on an outside surface of the patio door;

a first vertical slot located near the top of the sub-plate;

a first reinforcement block adapted to be located between the first sub-plate and the outside surface of the patio door;

a hole located in the first reinforcement block positioned to be in alignment with the first vertical slot;

a second vertical slot located near the bottom of the sub-plate;

a second reinforcement block adapted to be located between the first sub-plate and the outside surface of the patio door; and

a hole located in the second reinforcement block positioned to be in alignment with the second vertical slot;

wherein the first and second reinforcement blocks adjacent the first sub-plate are adapted to move toward or away from each other until the center to center spacing between the holes in the first and second reinforcement blocks are the same as the non-standard center to center spacing between the mounting holes on the patio door.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIGS. 1A-1D show prior art patio door multipoint locking mechanisms where different door manufacturer make difference door prep distances for the thru-bolts to lock hub and lever hub and the same door manufacturer may have different door prep for patio doors if different lock mechanisms are used;

FIG. 2 is a perspective view of an assembled universal multipoint lock lever set designed for use with patio doors, where the door is not shown, in accordance with the principles of the invention; and

FIG. 3 is an exploded view of the patio door universal multipoint lock lever set of FIG. 1 in accordance with the principles of the invention.

### DESCRIPTION OF THE PREFERRED EMBODIMENT

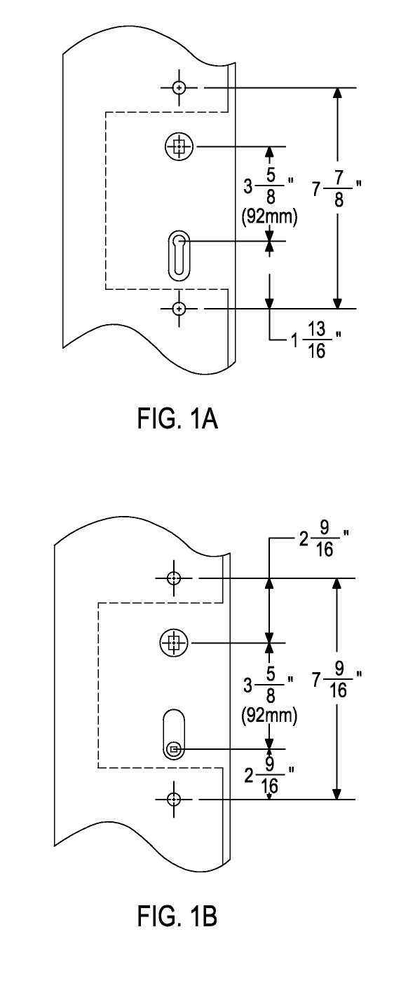

Door manufacturers make patio doors which use multipoint locking mechanisms. Different door manufacturer make difference door prep distances for the thru-bolts to lock hub and lever hub. Even the same door manufacturer may have various door preps if they use different lock mechanisms. For example, where the profile cylinder is below the handle, see FIG. 1A, some manufacturers such as Hoppe, Hurd, Eagle, Kolbe &Kolbe, Lincoln, Peachtree, Vetter, and others manufacture patio doors where the center to center spacing is 3 and ⅝ inches and the center to center spacing for the mounting holes is 7 and ⅞ inches.

Where the American cylinder is above or below the handle, see FIG. 1B, some manufacturers such as Eagle, BiltBest, Pella, Sierra Pacific, and others manufacture patio doors where the center to center spacing is 3 and ⅝ inches and the center to center spacing for the mounting holes is 7 and 9/16 inches.

Where the American cylinder is above the handle, see FIG. 1C, some manufacturers such as Caracdo, Marvin, and others manufacture patio doors where the center to center spacing is 3 and ⅝ inches and the center to center spacing for the mounting holes is 7 and ¼ inches.

Where the American cylinder is below the handle, see FIG. 1C, Pella manufactures patio doors where the center to center spacing is 3 and ⅝ inches and the center to center spacing for the mounting holes is 8 and ⅜ inches.

The inventor specializes in manufacturing design driven decorative door hardware for high end residential market. In the past few years the inventor has developed lever sets and trims for the home with interior doors, entry doors and patio doors. While interior doors are usually manufactured in a standard size, patio doors have always been a problem for many distributors. More often the distributor has to go to the home owner's house to measure the distance of the prep and figure out the functions. Therefore, instead of developing multiple tooling which is required to manufacture multiple sub plates, the inventor has designed a universal multipoint lock lever set which can be used with over 90% of the patio doors which are presently being manufactured. The lock lever set disclosed provides compatibility and flexibility for distributors and installers because it can be attached to patio doors with non-standard mounting holes, requires less tooling investment and less inventory for manufacturers and, when attached to a patio door, provides a clean and contemporary look.

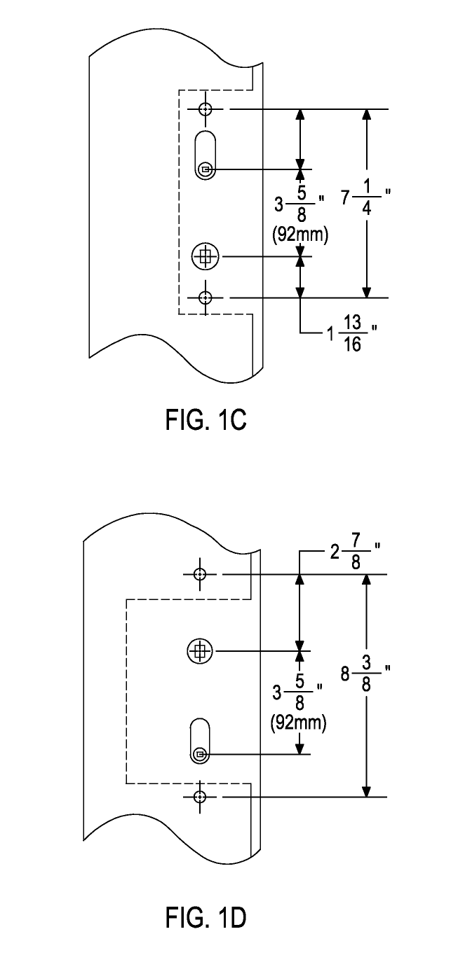

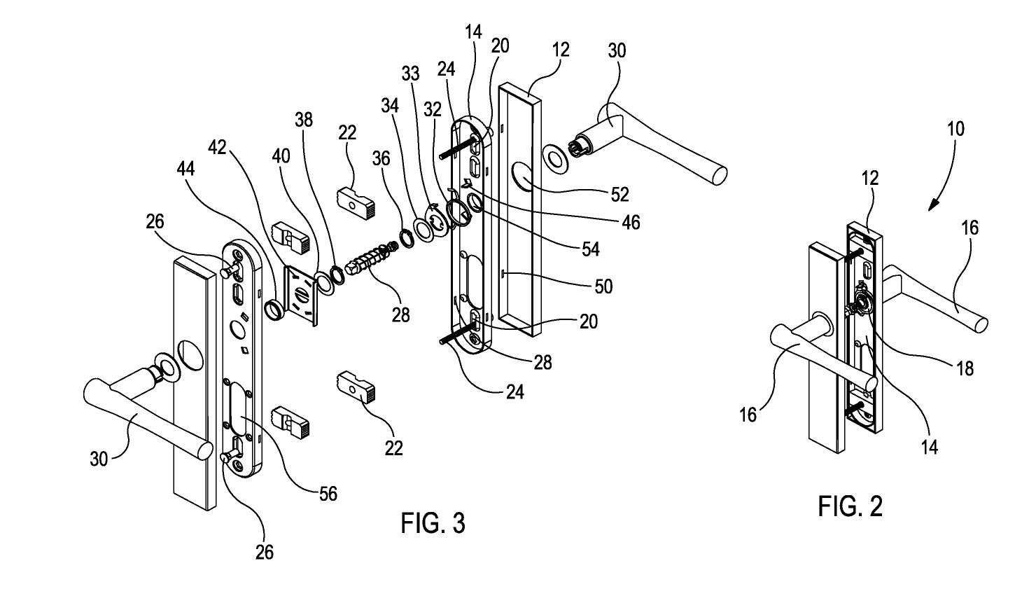

Looking at FIG. 2, there is shown a perspective view of an assembled universal multipoint lock lever set 10 designed for use with patio doors, where the patio door is not shown, in accordance with the principles of the invention. The lock lever set includes a cover plate 12 which is located over a sub-plate 14 designed to be attached to a patio door which has non-standard mounting holes or, stated differently, patio doors that have mounting holes which have different center to center spacing. The sub-plate 14 which is designed to be attached to patio doors with mounting holes on different center to center spacing has two vertical slots, one at each end of the sub-plate, more fully shown in FIG. 3. Each vertical slot cooperates with a reinforcement block located on the back side of the sub-plate. Each reinforcement block has a hole which is aligned with a slot for receiving a mounting bolt which is passed through the hole in the reinforcement block and the slot in the sub plate. Thus, the mounting bolts which are located in the two slots in the sub plate can slidably move toward and away from each other along the vertical slots in the sub plate until they are spaced apart a distance that is equal to the center to center spacing of the mounting holes in a patio door. Each reinforcement block has a length that is slightly less than the width of the sub plate and is located between the sides of the sub-plate. A slot in one surface of the reinforcement blocks is provided to receive the head of a mounting bolt. The spacing between the mounting bolts is adjusted to be equal to the center to center spacing of the holes in the patio door and the mounting bolts in the sub-plate are then inserted through the mounting holes in the patio door and are attached to another sub-plate which is located on the other side of the patio door with threaded sleeves. A more complete description of the universal multipoint lock lever set including the sub plates, reinforcement blocks and mounting bolts is provide in FIG. 3. Projecting out from the cover plates on each side of the patio door are patio door levers 16 which are connected together with various parts 18 more fully disclosed in FIG. 3.

Referring to FIG. 3, there is shown an exploded view of the patio door universal multipoint lock lever set of FIG. 2 for use with a patio door. The lock lever set includes a first sub-plate 14 designed to be attached to an outside surface of a patio door having mounting holes that have non-standard center to center spacing. The first sub-plate 14 which is designed to be attached to a patio door with mounting holes on non-standard center to center spacing has two vertical slots 20, one near each end of the sub-plate. Each vertical slot cooperates with a reinforcement block 22 slidably coupled to the back side of the sub-plate. Each reinforcement block has a hole which is aligned with a vertical slot for receiving a mounting bolt 24 which passes through the slot in the first sub-plate and the hole in the reinforcement block. Thus, mounting bolts which are located in the two slots in the first sub-plate can move up and down toward and away from each other within the vertical slots in the sub-plate to increase or decrease between them until the spacing between the bolts is equal to the center to center spacing of the mounting holes in a patio door. Each reinforcement block has a length that is slightly less than the width of the sub-plate to fit between side walls of the sub-plate and each reinforcement block has a slot in one surface which is aligned with the vertical slot in the sub-plate. The spacing between the mounting bolts is adjustable to be equal to the center to center spacing of the mounting holes in the patio door. Thus, mounting bolts in the sub-plate and reinforcement blocks can be inserted through mounting holes in the patio door and then through other reinforcement blocks and a second sub-plate on the other side of the patio door and attached to the patio door with threaded sleeves 26. Projecting out from the cover plates on each side of the patio door are hand levers.

Located within an opening in the patio door and positioned between the two sub-plates is a spindle 28 which is attached at each end to a patio door lever handle 30 with a set screw. Located on the spindle 28, and going from right to left is a bi-directional spring with a wide angle which allows the lever handles to go up and down which is required in most multipoint locking mechanisms. The spring also helps to keep the lever handles in a horizontal position and prevents sagging. Located next to the spring is an active driving plate 33 which is provided for active functions. Continuing with FIG. 3 and going from right to left, there is a first thin washer/spacer 34, a first circular clip 36, a second circular clip 38, a second thin washer/spacer 40, a dummy/inactive driving plate for dummy functions, 42, and a large washer 44. The back side of sub-plate 12 has a spring stop 46 which cooperates with the spring 32.

Each sub-plate 12 has bumps 48 which cooperate with dimples 50 on the cover plate 12 to allow the cover plate to have a snap on fit with the sub-plate. Thus, the sub-plate can be used with different cover plates to provide different functions such as a cover plate which has an opening for a lock mechanism or a cover plate which has no opening for receiving a locking mechanism. Each cover plate has a hole 52 which is aligned with a hole 54 through which an end of the spindle extends and is sized to receive the end of a lever handle. Each sub-plate has a cylinder hole 56 for receiving a locking mechanism.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A universal door lever set assembly for a patio door that has non-standard center to center spacing between mounting holes and rotates about at least two hinges to an open or close position comprising:
a first sub-plate having side walls which extend down from one side of the sub-plate wherein the edges of the side walls are adapted to be located on an outside surface of the patio door;
a first vertical slot located near the top of the sub-plate;
a first reinforcement block adapted to be located between the first sub-plate and the outside surface of the patio door;
a hole located in the first reinforcement block positioned to be in alignment with the first vertical slot;
a second vertical slot located near the bottom of the sub-plate;
a second reinforcement block adapted to be located between the first sub-plate and the outside surface of the patio door; and
a hole located in the second reinforcement block positioned to be in alignment with the second vertical slot;
wherein the first and second reinforcement blocks adjacent the first sub-plate are adapted to move toward or away from each other until the center to center spacing between the holes in the first and second reinforcement blocks is the same as the non-standard center to center spacing between the mounting holes on the patio door.

2. The universal door lever set assembly of claim 1 wherein the first and second reinforcement blocks slide up or down relative to the vertical slots.

3. The universal door lever set assembly of claim 2 wherein the thickness of the each reinforcement block is substantially equal to the depth of the side walls on the sub-plate.

4. The universal door lever set assembly of claim 3 wherein mounting bolts which are located in the vertical slots and aligned holes in the first and second reinforcement blocks are movable toward or away from each other until their center to center spacing is the same as the center to center spacing of the mounting holes in the patio door.

5. The universal door lever set assembly of claim 4 wherein the sub-plate includes a hole for receiving an end of a hand lever.

6. The universal door lever set assembly of claim 5 wherein the sub-plate has a spring stop which cooperates with a bi-directional spring which allows the hand lever to go up or down and helps keep the hand lever in a horizontal position.

7. The universal door lever set assembly of claim 6 wherein the sub-plate has a hole for receiving a locking mechanism.

8. The universal door lever set assembly of claim 7 wherein a cover plate having a hole for receiving an end of a hand lever is coupled to the sub-plate.

9. The universal door lever set assembly of claim 1 wherein the sub-plate has bumps on its side walls which provide a snap on fit for the cover plate.

10. The universal door lever set assembly of claim 9 wherein the cover plate has dimples which engage the bumps on the sub-plate to provide a snap on fit for the cover plate.

11. The universal door lever set assembly of claim 10 wherein the sub-plate is adapted to be attached to at least two different cover plates where each cover plate has a specific function.

12. The universal door lever set assembly of claim 11 wherein the cover plate conceals the sub-plate.

13. The universal door lever set assembly of claim 2 wherein a second sub-plate having side walls which extend down from one side of the sub-plate where the edges of the side walls are adapted to be located on an inside surface of the patio door;
a first vertical slot located near the top of the second sub-plate;
a first reinforcement block adapted to be located between the second sub-plate and the inside surface of the patio door;
a hole located in the first reinforcement block positioned to be in alignment with the first vertical slot;
a second vertical slot located near the bottom of the second sub-plate;
a second reinforcement block adapted to be located between the second sub-plate and the inside surface of the patio door; and
a hole located in the second reinforcement block positioned to be in alignment with the second vertical slot;
wherein the first and second reinforcement blocks adjacent the second sub-plate are adapted to move toward or away from each other until the center to center spacing between the holes in the first and second reinforcement blocks is the same as the center to center spacing between the mounting holes on the patio door;
wherein mounting bolts located in the vertical slots and aligned holes in the first and second reinforcement blocks of the first sub-plate are movable toward or away from each other until their center to center spacing is the same as the center to center spacing of the mounting holes in the patio door and the center to center spacing of the holes in the first and second reinforcement blocks between the second sub-plate and the inside surface of the patio door; and
wherein fastening means are coupled to the mounting bolts to attach the first and second sub-plates to the patio door.
